(19) United States
(12) Patent Application Publication
(10) Pub. No.: US 2026/0342462 A1
(43) Pub. Date: Oct. 29, 2026

(54) PROPAGATION LOSS ESTIMATION METHOD, PROPAGATION LOSS ESTIMATION SYSTEM, PROPAGATION LOSS ESTIMATION DEVICE, AND PROPAGATION LOSS ESTIMATION PROGRAM

(71) Applicant: NTT, Inc., Tokyo (JP)

(72) Inventors: Minoru INOMATA, Musashino-shi, Tokyo (JP); Wataru YAMADA, Musashino-shi, Tokyo (JP); Nobuaki KUNO, Musashino-shi, Tokyo (JP)

(73) Assignee: NTT, Inc., Tokyo (JP)

(21) Appl. No.: 19/123,176

(22) PCT Filed: Oct. 27, 2022
(86) PCT No.: PCT/JP2022/040198

§ 371 Date: Apr. 22, 2025

(51) Int. Cl. H04B 17/391; H04W 16/20

(52) U.S. Cl. CPC H04B 17/3912; H04W 16/20

(57) ABSTRACT

This propagation loss estimation method includes creating an outdoor 3D CAD model; reading, from the outdoor 3D CAD model, data concerning materials constituting the terrestrial feature, transmission characteristics of each of the materials, and abundance proportions of each of the materials in the terrestrial feature; calculating a penetration point from a positional relationship between the terminal and the terrestrial feature; calculating an outdoor distance from positions of the base station and the penetration point; calculating an indoor distance from positions of the penetration point and the terminal; calculating an outdoor propagation loss based on the outdoor distance; calculating an indoor propagation loss based on the indoor distance; calculating a penetration loss based on the materials constituting the terrestrial feature, the abundance proportions, and the transmission characteristics; and calculating a propagation loss based on the outdoor propagation loss, the indoor propagation loss, and the penetration loss.

### TECHNICAL FIELD

The present disclosure relates to a propagation loss estimation method, a propagation loss estimation system, a propagation loss estimation device, and a propagation loss estimation program.

### BACKGROUND ART

When performing wireless communication over a plurality of areas, the penetration loss characteristics of penetrating waves are estimated to design the wireless system. Particularly, in area design in environments in which radio waves enter indoors from the outdoors, the penetration loss characteristics of radio waves entering buildings, structure objects, or vegetation from the outdoors are estimated.

For example, in a local area, there are structure objects having various material compositions, such as vegetation in factories, hospitals or farms. For this reason, in order to estimate the penetration loss characteristics with high accuracy, an estimation method which corresponds to the characteristics of the relevant structure object is required.

Generally, the penetration loss of radio waves entering a structure object having a plurality of material compositions is calculated for each material. For example, first, the outdoor 3D CAD model of the relevant area is classified for each material. Also, the surface of the structure object into which the radio waves penetrate is divided into surface elements for each material. Furthermore, after calculating the penetration loss of the transmission path for each surface element, the results of each path are summed. By increasing the number of surface elements into which there is division, calculation accuracy can be further improved.

### CITATION LIST

### Non Patent Literature

Non Patent Literature 1: P. Pongsilamanee and H. L. Bertoni, “Specular and nonspecular scattering from building facades,” in IEEE Transactions on Antennas and Propagation, vol. 52, No. 7, pp. 1879-1889, July 2004.

### SUMMARY OF INVENTION

### Technical Problem

Here, the calculation time for the above-described penetration loss increases in accordance with the number of surface elements. For this reason, when an area is divided into more surface elements to improve calculation accuracy, there is a problem in that an extremely large amount of calculation time is required.

In order to solve the above-described problems, a first object of the present disclosure is to provide a propagation loss estimation method which can estimate penetration loss characteristics with high accuracy without increasing calculation time.

Also, a second object of the present disclosure is to provide a propagation loss estimation system which can estimate penetration loss characteristics with high accuracy without increasing calculation time.

Furthermore, a third object of the present disclosure is to provide a propagation loss estimation device which can estimate penetration loss characteristics with high accuracy without increasing calculation time.

In addition, a fourth objective of the present disclosure is to provide a propagation loss estimation program which can estimate penetration loss characteristics with high accuracy without increasing calculation time.

### Solution to Problem

It is preferable that a first aspect of the present disclosure be a propagation loss estimation method which calculates a propagation loss of radio waves penetrating into a terrestrial feature for each combination of a base station and a terminal, the method including: creating an outdoor 3D CAD model; reading, from the outdoor 3D CAD model, data concerning materials constituting the terrestrial feature, transmission characteristics of each of the materials, and abundance proportions of each of the materials in the terrestrial feature; calculating a penetration point from a positional relationship between the terminal and the terrestrial feature; calculating an outdoor distance from positions of the base station and the penetration point; calculating an indoor distance from positions of the penetration point and the terminal; calculating an outdoor propagation loss on the basis of the outdoor distance; calculating an indoor propagation loss on the basis of the indoor distance; calculating a penetration loss on the basis of the materials constituting the terrestrial feature, the abundance proportions, and the transmission characteristics; and calculating a propagation loss on the basis of the outdoor propagation loss, the indoor propagation loss, and the penetration loss.

It is preferable that a second aspect of the present disclosure be a propagation loss estimation system which calculates a propagation loss of radio waves penetrating into a terrestrial feature for each combination of a base station and a terminal, the system including: a model creation device and a propagation loss estimation device, wherein the model creation device is configured to perform creating an outdoor 3D CAD model, and the propagation loss estimation device is configured to perform reading, from the outdoor 3D CAD model, data concerning materials constituting the terrestrial feature, transmission characteristics of each of the materials, and abundance proportions of each of the materials in the terrestrial feature; calculating a penetration point from a positional relationship between the terminal and the terrestrial feature; calculating an outdoor distance from a distance between the base station and the penetration point; calculating an indoor distance from a distance between the penetration point and the terminal; calculating an outdoor propagation loss on the basis of the outdoor distance; calculating an indoor propagation loss on the basis of the indoor distance; calculating penetration loss on the basis of the materials constituting the terrestrial feature, the abundance proportions, and the transmission characteristics; and calculating a propagation loss on the basis of the outdoor propagation loss, the indoor propagation loss, and the penetration loss.

It is preferable that a third aspect of the present disclosure be a propagation loss estimation device which calculates a propagation loss of radio waves penetrating into a terrestrial feature for each combination of a base station and a terminal using an outdoor 3D CAD model, the device is configured to perform: processing of reading, from the outdoor 3D CAD model, data concerning materials constituting the terrestrial feature, transmission characteristics of each of the materials, and abundance proportions of each of the materials in the terrestrial feature; processing of calculating a penetration point from a positional relationship between the terminal and the terrestrial feature; processing of calculating an outdoor distance from a distance between the base station and the penetration point; processing of calculating an indoor distance from a distance between the penetration point and the terminal; processing of calculating an outdoor propagation loss on the basis of the outdoor distance; processing of calculating an indoor propagation loss on the basis of the indoor distance; processing of calculating penetration loss on the basis of the materials constituting the terrestrial feature, the abundance proportions, and the transmission characteristics; and processing of calculating a propagation loss on the basis of the outdoor propagation loss, the indoor propagation loss, and the penetration loss.

It is preferable that a fourth aspect of the present disclosure be a propagation loss estimation program which causes a propagation loss estimation device to calculate a propagation loss of radio waves penetrating into a terrestrial feature for each combination of a base station and a terminal using an outdoor 3D CAD model, the propagation loss estimation program including a program causing a computer to execute: processing of reading, from the outdoor 3D CAD model, data concerning materials constituting the terrestrial feature, transmission characteristics of each of the materials, and abundance proportions of each of the materials in the terrestrial feature; processing of calculating a penetration point from a positional relationship between the terminal and the terrestrial feature; processing of calculating an outdoor distance from a distance between the base station and the penetration point; processing of calculating an indoor distance from a distance between the penetration point and the terminal; processing of performing line-of-sight determination to determine whether there is a shielding object between the base station and the terminal; processing of calculating an outdoor propagation loss on the basis of the outdoor distance; processing of calculating an indoor propagation loss on the basis of the indoor distance; processing of calculating penetration loss on the basis of the materials constituting the terrestrial feature, the abundance proportions, and the transmission characteristics; and processing of calculating a propagation loss on the basis of the outdoor propagation loss, the indoor propagation loss, and the penetration loss.

### Advantageous Effects of Invention

According to the first to fourth aspects of the present disclosure, it is possible to estimate penetration loss characteristics with high accuracy without increasing calculation time.

### BRIEF DESCRIPTION OF DRAWINGS

FIG. 1 is a chart for describing a procedure for generating an outdoor 3D CAD model according to Embodiment 1 of the present disclosure.

FIG. 2 is a diagram showing a model of a radio wave penetration route according to Embodiment 1 of the present disclosure.

FIG. 3 is a flowchart for describing a propagation loss estimation method according to Embodiment 1 of the present disclosure.

FIG. 4 is a diagram showing a propagation loss estimation system according to Embodiment 1 of the present disclosure.

FIG. 5 is a diagram showing a hardware configuration of a propagation loss estimation device according to Embodiment 1 of the present disclosure.

### DESCRIPTION OF EMBODIMENTS

### First Embodiment

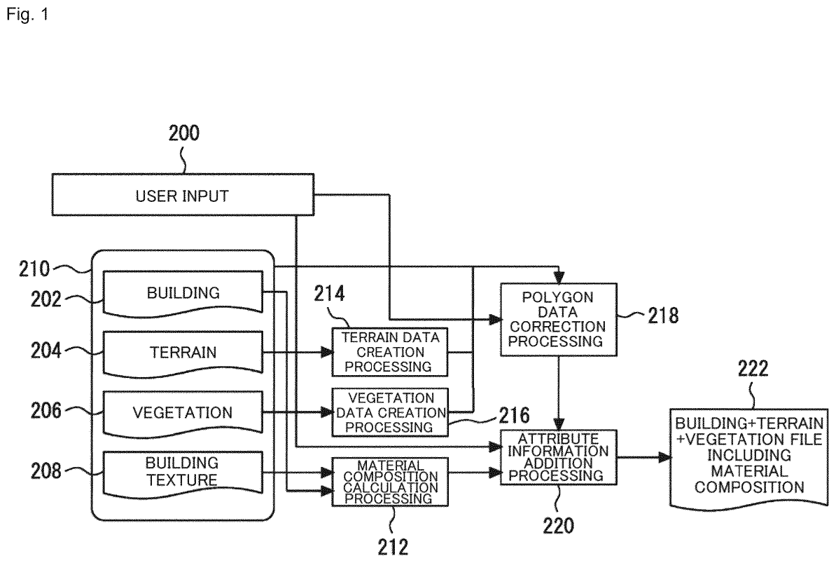

FIG. 1 is a chart for describing a procedure for generating an outdoor 3D CAD model according to Embodiment 1 of the present disclosure. In order to generate an outdoor 3D CAD model, first, a user input 200 is provided for pieces of information necessary for generating the outdoor 3D CAD model. The pieces of necessary information include, for example, a material, a cutting range, a topography capture flag, a vegetation capture flag, and the like. These pieces of information are used in polygon data correction processing 218 or attribute information addition processing 220 which will be described later.

Furthermore, specific digital data is input as a digital data input 210. Here, building data 202, terrain data 204, vegetation data 206, and building texture data 208 are input.

The building data 202 and the building texture data 208 are used in material composition calculation processing 212. In the material composition calculation processing 212, building data and material composition data are linked. For example, the material composition is directly input into each piece of building data included in the building data 202. Alternatively, the material composition is automatically determined from the building texture data 208 and provided to each piece of building data.

The terrain data 204 is used in terrain data creation processing 214. Here, it is assumed that the terrain data is in a file format having polygons, attributes, and a database. An example of the file format includes a shape file format.

The vegetation data 206 is used in vegetation data creation processing 216. Here, it is assumed that the terrain data is in a file format having polygons, attributes, and a database. An example of the file format includes a shape file format.

The data processed in the terrain data creation processing 214 and the vegetation data creation processing 216 is used in the polygon data correction processing 218, together with information input through the user input 200 and the digital data input 210. First, the file is read. Subsequently, building and vegetation data is placed over the relevant terrain. Finally, cutting is performed within the user-specified range.

The data processed in the polygon data correction processing 218 and the material composition calculation processing 212 is used in the attribute information addition processing 220, together with the information input by the user input 200. In the attribute information addition processing 220, a type and a material are linked. Examples of types include buildings, structure objects, and vegetation. Examples of materials include concrete, wood, ground, and other compositions for each material.

The data output in the attribute information addition processing 220 is intermediately output as a file 222 of buildings, terrain, and vegetation including a material composition. This file is used for the outdoor 3D CAD model used in this disclosure.

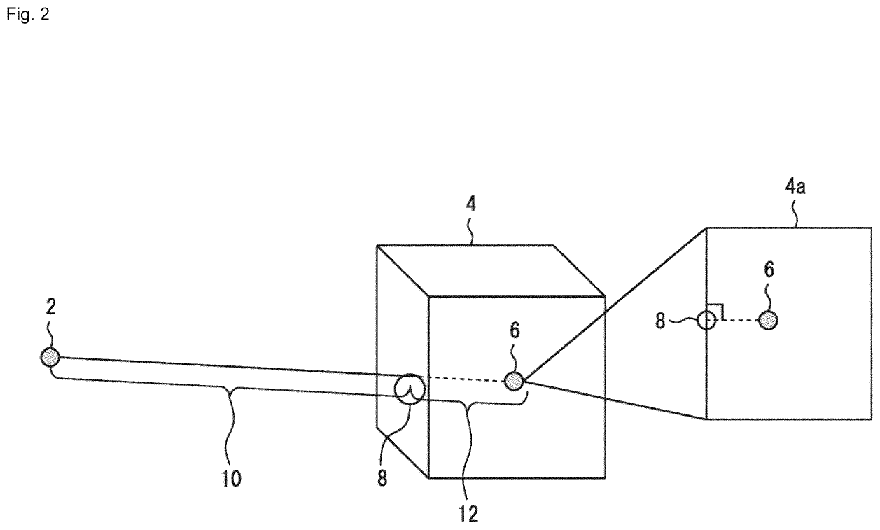

FIG. 2 is a diagram showing a model of a radio wave penetration route according to Embodiment 1 of the present disclosure. In the embodiment, penetration loss characteristics are estimated for each combination of a Base Station (BS) and a terminal (User Equipment: UE) through calculation using information extracted from an outdoor 3D CAD model. Here, a model of the radio wave penetration path used for calculating the penetration loss characteristics is shown.

The radio waves emitted by the base station 2 penetrate into a terrestrial feature 4. The terrestrial feature 4 is, for example, a human-made structure object or naturally existing vegetation. The radio waves which have penetrated into the terrestrial feature 4 reach the terminal 6. At this time, the point in which the radio wave penetrates into the terrestrial feature 4 is defined as a penetration point 8. Furthermore, it is assumed that a distance from the base station 2 to the penetration point 8 is an outdoor distance 10 (dout) and a distance from the penetration point 8 to the terminal 6 is an indoor distance 12 (din).

The penetration point 8 will be described in detail. The terrestrial feature 4a is a cross section of the terrestrial feature 4 cut parallel to the ground at the height of the terminal 6. The penetration point 8 is a point at which the distance from the terminal 6 is the shortest in the plane in which the line segments of the base station 2 and the terminal 6 of the terrestrial feature 4 intersect. When calculating the penetration radio waves passing through this penetration point 8, the resulting propagation loss is the smallest because the propagation path is the shortest. When estimating the reception power of a wireless communication system, it is important to search for a propagation path with the smallest propagation loss. Thus, the penetration point 8 is defined as described above.

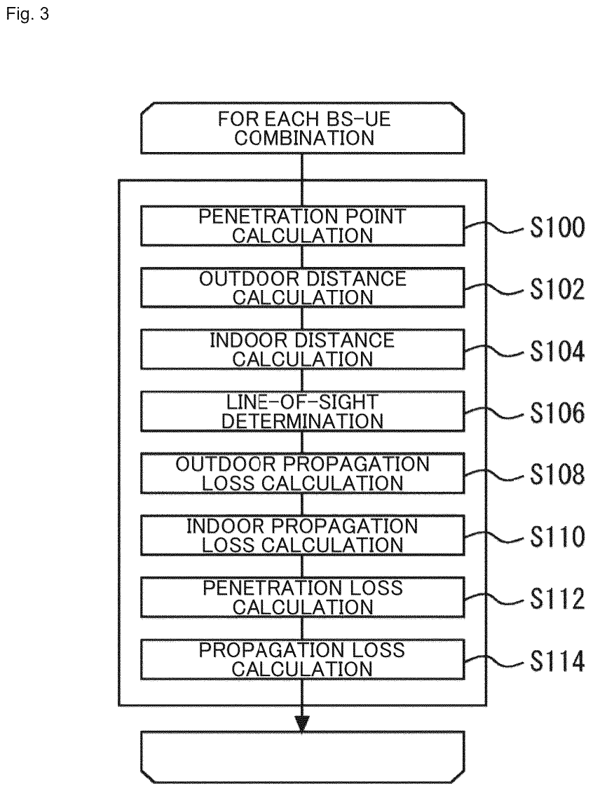

FIG. 3 is a flowchart for describing a propagation loss estimation method according to Embodiment 1 of the present disclosure. Here, the procedure for estimating a propagation loss performed for each combination of the base station and the terminal will be described.

First, in Step 100, a penetration point is calculated. As described above, the penetration point 8 is determined to be the shortest point which is a distance from the terminal 6 on the plane into which the radio waves penetrate.

Subsequently, in Step 102, an outdoor distance is calculated. The outdoor distance 10 is the distance from the base station 2 to the penetration point 8, as described above.

Subsequently, in Step 104, an indoor distance is calculated. The indoor distance 12 is the distance from the penetration point 8 to the terminal 6, as described above.

Subsequently, in Step 106, a line-of-sight determination is performed. The line-of-sight determination is processing of determining whether there is a shielding object between the base station 2 and the terminal 6. According to the determination result, a value used for calculating an outdoor propagation loss PLoutdoor which will be described later changes.

Subsequently, in Step 108, outdoor propagation loss calculation is performed. The outdoor propagation loss PLoutdoor is calculated using the following expression.

PL_{outdoor}=α log₁₀ dₒᵤₜ+β+γ log₁₀ f [Math. 1]

Note that α, β, and γ are values derived in advance through multiple regression calculation using pieces of outdoor propagation loss data. These parameters are set to different values for each environment such as an urban area or a residential area, or for each line-of-sight environment or non-line-of-sight environment.

Subsequently, in Step 110, indoor propagation loss calculation is performed. The indoor propagation loss PLindoor is calculated using the following expression.

PL_{indoor}=0.5dᵢₙ [Math. 2]

Subsequently, in Step 112, penetration loss calculation is performed. The penetration loss PLpenetration is derived using the following expression.

$${PL}_{penetration} = 5 - 10 {log}_{10} ( \sum {X}_{i} \cdot {10}^{\frac{- {L}_{i}}{10}} ) \qquad [ Math . 3 ]$$

Here, Xi is a proportion of a material i and Li is a transmission property of the material i. When the terrestrial feature 4 is not naturally existing vegetation, Li is derived using the following expression. An example of a case in which an object is not naturally existing vegetation is a case in which the object is a structure object built by humans.

Lᵢ=a+bf [Math. 4]

Furthermore, when the terrestrial feature 4 is naturally existing vegetation, Li is derived using the following expression.

Lᵢ=af^{b} [Math. 5]

Note that a and b are values derived in advance through multiple regression calculation using transmission loss data for each material. These parameters are set to different values on the basis of the characteristics of the terrestrial feature. Furthermore, when the terrestrial feature 4 has a plurality of materials, PLpenetration is calculated for all the materials and then summed.

Finally, in Step 114, propagation loss calculation is performed. The propagation loss PL is derived using the following expression.

PL=PL_{outdoor}+PLₚₑₙₑₜᵣₐₜᵢₒₙ+PL_{indoor} [Math. 6]

As described above, the propagation loss can be easily derived by defining the penetration point and calculating and summing the three losses based on the material for each terrestrial feature. Thus, the penetration loss characteristics can be estimated with high accuracy without increasing calculation time.

Note that, in the above-described propagation loss estimation, in addition to the data included in the outdoor 3D CAD described above, data included in the design condition file is referred to. Examples of data included in outdoor 3D CAD include data on buildings, terrain, and vegetation, including material composition, included in shape files. Examples of data included in the design condition file include data regarding coordinates of bases and terminals, directions of base stations, and information on base stations and terminal devices.

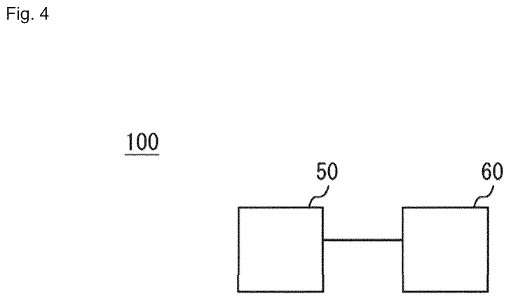

FIG. 4 is a diagram showing a propagation loss estimation system according to Embodiment 1 of the present disclosure. The propagation loss estimation system 100 is a system in which the above-described propagation loss estimation method can be performed all at once.

The propagation loss estimation system 100 includes a model creation device 50. The model creation device 50 creates the outdoor 3D CAD model described in FIG. 1.

Furthermore, the propagation loss estimation system 100 includes a propagation loss estimation device 60. The propagation loss estimation device 60 estimates the propagation loss using the propagation loss estimation procedure described in FIG. 3.

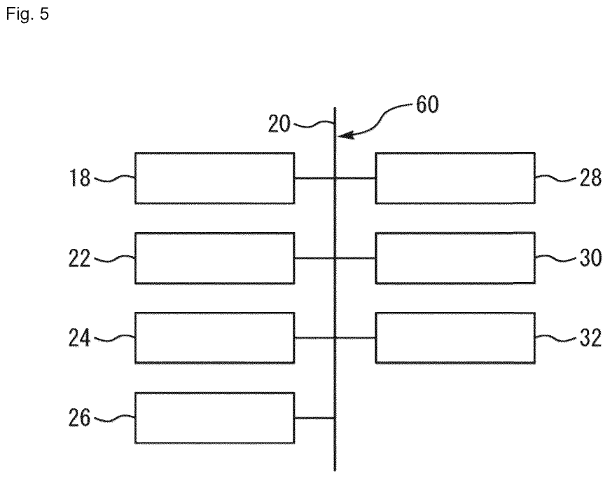

FIG. 5 is a diagram showing a hardware configuration of a propagation loss estimation device according to Embodiment 1 of the present disclosure. The propagation loss estimation device 60 includes a CPU 18. The CPU 18 is connected to a bus line 20. Memory devices such as a ROM 22, a RAM 24, and a storage 26 are connected to the bus line 20. A propagation loss estimation program executed using the CPU 18 is stored in a memory device. The propagation loss estimation device 60 realizes functions unique to the embodiment when the CPU 18 executes the propagation loss estimating program.

A communication interface 28 is also connected to the bus line 20. The propagation loss estimation device 60 realizes communication with the network via the communication interface 28. An operation part 30 and a display part 32 are further connected to the bus line 20. The operation part 30 and the display part 32 function as a user interface for handling the propagation loss estimation device 60.

As explained above, according to the propagation loss estimating method of the embodiment, unlike the method in the related art, a propagation loss can be easily derived. Thus, the penetration loss characteristics can be estimated with high accuracy without increasing calculation time.

Note that, although the propagation loss estimation device 60 executes the processing necessary for propagation loss estimation in Embodiment 1 described above, the present disclosure is not limited to this. For example, the propagation loss estimation program may be provided to the service provision PC and the service provision PC may execute the processing.

### REFERENCE SIGNS LIST

2 Base station
4 Terrestrial feature
4a Terrestrial feature
6 Terminal
8 Penetration point
Outdoor distance
12 Indoor distance
14 Model creation device
16 Propagation loss estimation device
100 Propagation loss estimation system

1. A propagation loss estimation method which calculates a propagation loss of radio waves penetrating into a terrestrial feature for each combination of a base station and a terminal, the method comprising:
creating an outdoor 3D CAD model;
reading, from the outdoor 3D CAD model, data concerning materials constituting the terrestrial feature, transmission characteristics of each of the materials, and abundance proportions of each of the materials in the terrestrial feature;
calculating a penetration point from a positional relationship between the terminal and the terrestrial feature;
calculating an outdoor distance from positions of the base station and the penetration point;
calculating an indoor distance from positions of the penetration point and the terminal;
calculating an outdoor propagation loss on the basis of the outdoor distance;
calculating an indoor propagation loss on the basis of the indoor distance;
calculating a penetration loss on the basis of the materials constituting the terrestrial feature, the abundance proportions, and the transmission characteristics; and
calculating a propagation loss on the basis of the outdoor propagation loss, the indoor propagation loss, and the penetration loss.

2. The propagation loss estimation method according to claim 1, wherein the penetration point is
a point at which a distance from the terminal is the shortest on a surface of the terrestrial feature into which the radio waves penetrate.

3. The propagation loss estimation method according to claim 1, wherein the penetration loss is
a value obtained by summing penetration losses calculated for each material when the terrestrial feature is composed of the plurality of materials.

4. The propagation loss estimation method according to claim 1, comprising: performing line-of-sight determination to determine whether there is a shielding object between the base station and the terminal,
wherein the outdoor propagation loss is
calculated on the basis of multiple regression calculation, and
parameters of a calculation expression of the multiple regression calculation are set on the basis of the determination result of the line-of-sight determination.

5. The propagation loss estimation method according to claim 1, wherein the transmission characteristics are
calculated on the basis of multiple regression calculation, and
parameters of a calculation expression of the multiple regression calculation are set on the basis of characteristics of the terrestrial feature.

6. A propagation loss estimation system which calculates a propagation loss of radio waves penetrating into a terrestrial feature for each combination of a base station and a terminal, the system comprising:
a model creator and a propagation loss estimator,
wherein the model creator is
configured to perform creating an outdoor 3D CAD model, and
the propagation loss estimator is configured to perform
reading, from the outdoor 3D CAD model, data concerning materials constituting the terrestrial feature, transmission characteristics of each of the materials, and abundance proportions of each of the materials in the terrestrial feature;
calculating a penetration point from a positional relationship between the terminal and the terrestrial feature;
calculating an outdoor distance from a distance between the base station and the penetration point;
calculating an indoor distance from a distance between the penetration point and the terminal;
calculating an outdoor propagation loss on the basis of the outdoor distance;
calculating an indoor propagation loss on the basis of the indoor distance;
calculating a penetration loss on the basis of the materials constituting the terrestrial feature, the abundance proportions, and the transmission characteristics; and
calculating a propagation loss on the basis of the outdoor propagation loss, the indoor propagation loss, and the penetration loss.

7. A propagation loss estimator which calculates a propagation loss of radio waves penetrating into a terrestrial feature for each combination of a base station and a terminal using an outdoor 3D CAD model, the estimator is configured to perform:
processing of reading, from the outdoor 3D CAD model, data concerning materials constituting the terrestrial feature, transmission characteristics of each of the materials, and abundance proportions of each of the materials in the terrestrial feature;
processing of calculating a penetration point from a positional relationship between the terminal and the terrestrial feature;
processing of calculating an outdoor distance from a distance between the base station and the penetration point;
processing of calculating an indoor distance from a distance between the penetration point and the terminal;
processing of calculating an outdoor propagation loss on the basis of the outdoor distance;
processing of calculating an indoor propagation loss on the basis of the indoor distance;
processing of calculating a penetration loss on the basis of the materials constituting the terrestrial feature, the abundance proportions, and the transmission characteristics; and
processing of calculating a propagation loss on the basis of the outdoor propagation loss, the indoor propagation loss, and the penetration loss.

8. A storage medium storing a computer readable propagation loss estimation program configured to cause a computer to execute the propagation loss estimation method according to claim 1.
